(19) United States
(12) Patent Application Publication
(10) Pub. No.: US 2004/0076380 A1
(43) Pub. Date: Apr. 22, 2004

(54) Optical connector

(75) Inventors: Kazuhiro Asada, Nagoya-shi (JP); Hayato Yuuki, Nagoya-shi (JP); Yuji Nakura, Nagoya-shi (JP); Momoe Yagi, Nagoya-shi (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Nagoya-shi (JP); SUMITOMO WIRING SYSTEMS, LTD., Yokkaichi-city (JP); SUMITOMO ELECTRIC INDUSTRIES, LTD., Osaka-shi (JP)

(21) Appl. No.: 10/680,223

(22) Filed: Oct. 8, 2003

(30) Foreign Application Priority Data
Oct. 22, 2002 (JP) 2002-307308
Nov. 1, 2002 (JP) 2002-319614

(51) Int. Cl. G02B 6/42

(52) U.S. Cl. 385/88

(57) ABSTRACT

A first housing for storing and holding a surface-implemented type optical element and a second housing to which an optical connector of the other party fits and connects are provided separately. In the first housing, a fixing pin to be soldered to a wiring substrate is vertically provided, and a guide sleeve portion for guiding an optical fiber toward the optical element projects. The position mounting the first housing can be freely adjusted in a range that the fixing pin can be movably inserted to a through-hole of the wiring substrate and can move inside. The second housing has a lock portion for maintaining the connection state with the optical connector of the other party. The first housing alternatively includes a first housing body portion having an element storing depression for storing and holding an optical element, a guide sleeve portion for guiding an optical fiber toward the optical element within the element storing depression, and a mounting lock portion, which can be mounted and fixed to the wiring substrate. An elastic forcing piece for forcing the optical element toward the main surface of the wiring substrate is provided in the first housing body portion.

### CLAIM FOR PRIORITY

The present invention claims priority to Japanese Patent Applications JP-A2002-307308 filed Oct. 22, 2002 and JP-A-2002-319614 filed Nov. 1, 2002.

### BACKGROUND OF THE NVENTION

1. Field of Invention

The present invention relates to an optical connector used in the optical communication field for OA, FA, car-mounted equipment and so on. More specifically, the present invention relates to an optical connector used for connecting an optical element and an optical fiber.

2. Description of Related Art

A conventional optical connector storing an optical element may be implemented on a wiring substrate. See JP-A-2001-296455, for example. The optical connector is connected to an optical connector of the other party holding an optical fiber so as to obtain the optical connection between the optical fiber and the optical element.

In this kind of conventional optical connector, an optical element with a lead terminal is stored and held in a connector housing. The optical element is electrically connected to a wiring pattern of a wiring substrate through the lead terminal. The optical element is fixed to the wiring pattern of the wiring substrate through the lead terminal. The connector housing, that stores and holds the optical element, is screwed to the wiring substrate. A slight difference in mounted position between the optical element and the connector housing can be absorbed by the deformation of the lead, and is not a big problem.

Also, an optical element with a lead terminal is stored and held in a connector housing, and the optical element is electrically connected to a wiring pattern of a wiring substrate through the lead terminal.

An optical element may be of a smaller, surface-implemented type in which position differences can cause problems. When the optical element is applied to the optical connector, the surface-implemented type optical element may be stored and held at a position where the optical element can be surface-implemented on the wiring substrate within the connector housing.

However, a position difference between the optical element and the connector housing screwed to the wiring substrate cannot be absorbed. The optical element is surface-implemented and fixed on the wiring substrate. The connector housing is secured to the wiring substrate by screwing. Thus, stresses at a solder position between the electrode portion of the optical element and the wiring pattern of the wiring substrate may cause cracks.

Accordingly, the invention provides an optical connector storing a surface-implemented type, wherein the optical connector can prevent stress onto the part soldering the electrode portion of the optical element and the wiring pattern of the wiring substrate.

When the optical element is applied to the optical connector, the surface-implemented type optical element may be stored and held at a position where the optical element can be surface-implemented on the wiring substrate. When the bottom surface of the connector housing and the bottom surface of the optical element do not precisely match, and when the bottom surface of the connector housing is tightly provided on the wiring substrate, the electrode portion of the optical element may not be soldered well to the wiring pattern of the wiring substrate.

Accordingly, the invention provides an optical connector, including a surface-implemented type optical element, wherein the electrode portion of the optical element can be more securely soldered to a wiring pattern of a wiring substrate.

### SUMMARY OF THE INVENTION

In order to solve the problem, the invention provides an optical connector and a first housing. The optical connector is implemented and fixed to a wiring substrate. The optical connector includes a surface-implemented type optical element. The first housing includes a first housing body portion having an element storing depression, a guide sleeve portion, and a first mounting portion. The element storing depression can store and hold the optical element so as to surface-implement the optical element on the main surface side of the wiring substrate. The guide sleeve portion guides a fiber so as to optically connect to the optical element. The first mounting portion mounts the first housing body portion onto the main surface of the wiring substrate. The first mounting portion is arranged such that the position mounting the first housing body portion can be freely adjusted in the planer direction of the wiring substrate.

The first mounting portion may be arranged such that the first mounting portion can be fixed to the wiring substrate side by soldering or with resin. The first mounting portion may have a fixing pin. The fixing pin can be movably inserted to a through-hole for fixing the first housing formed on the wiring substrate side. The fixing pin may be arranged to be fixed to the wiring substrate side by soldering or with resin.

The invention provides that the first mounting portion may be a substrate fixing lock portion. The lock portion has an extending lock piece, which can be movably inserted to an associating hole. The extending lock piece fixes the first housing formed on the wiring substrate side and a lock projection, which projects at the pointed end of the extending lock piece and can associate with the associating hole therethrough.

The optical connector may further include a second housing. The second housing is mounted and fixed to the wiring substrate by covering the first housing. The second housing guides the optical fiber toward the guide sleeve portion by fitting and connecting the housing of an optical connector of the other party holding the optical fiber to the second housing. The second housing may have a lock portion, which can be associated with the optical connector side of the other party. The second housing may have a screwed portion, which can be screwed and fixed to the wiring substrate.

The first housing may contain a material having a higher conductivity than that of the second housing, and at least a part thereof may be exposed to the outside of the second housing. The first housing may contain a material which does not melt at a processing temperature for surface-implementing the optical element thereto.

The invention also provides an optical connector for storing an optical element and implemented on a main surface of a wiring substrate. The optical connector includes a surface-implemented type optical element and a first housing. The optical element includes an electrode portion on a surface of an element body portion. The first housing includes a housing body portion having an element storing depression, a guide sleeve portion and a mounting portion. The element storing depression stores and holds the optical element so as to surface-implement the optical element to the wiring substrate. The guide sleeve portion guides an optical fiber so as to optically connect to the optical element. The mounting portion mounts and fixes the housing body portion to the wiring substrate. The mounting portion provides the bottom part of the housing body portion tightly in contact with the main surface of the wiring substrate. An element forcing portion for forcing the optical element toward the main surface of the wiring substrate is provided in the housing body portion.

The invention provides that the mounting portion may be a mounting lock portion, which can lockably associate with an associating hole by being inserted from the main surface side of the wiring substrate to the associating hole on the wiring substrate side. The invention provides that the element forcing portion may be a tongue-shaped elastic forcing piece, which is obtained by providing a substantial U-shaped slit on the ceiling part of the housing body portion.

The invention provides that the optical connector may further include a second housing, mounted and fixed to the wiring substrate by covering the first housing, for guiding the optical fiber toward the guide sleeve portion by fitting and connecting the housing of an optical connector of the other party holding the optical fiber to the second housing. In this case, the invention provides that the second housing has a lock portion, which can be latched to the optical connector of the other party.

### BRIEF DESCRIPTION OF THE DRAWINGS

Various exemplary embodiments of the devices, systems and methods of this invention will be described in detail with reference to the following figures, wherein:

FIG. 1 is an exploded perspective diagram showing an optical connector according to a first embodiment of the invention;

FIG. 2 is a section diagram showing the optical connector;

FIG. 3 is a perspective diagram showing a state where the optical connector is implemented and fixed to a wiring substrate;

FIG. 4 is an exploded perspective diagram showing an optical connector according to a second embodiment;

FIG. 5 is a perspective diagram showing a state where a first housing is mounted and fixed to a wiring substrate;

FIG. 6 is a front diagram showing a state where the first housing is mounted and fixed to the wiring substrate;

FIG. 7 is a vertical section diagram showing a state where the substrate fixing lock portion associates with the wiring substrate;

FIG. 8 is a horizontal section diagram showing the same state;

FIG. 9 is an exploded perspective diagram showing an optical connector according to a third embodiment;

FIG. 10 is a perspective diagram showing a state where a first housing is mounted and fixed to the wiring substrate;

FIG. 11 is a horizontal section diagram showing a state where the substrate fixing lock portion associates with the wiring substrate;

FIG. 12 is an exploded perspective diagram showing an optical connector for a fourth embodiment;

FIG. 13 is a section diagram showing the optical connector;

FIG. 14 is a perspective diagram showing a state where the optical connector is implemented and fixed to a wiring substrate;

FIG. 15 is a section diagram showing a first housing; and

FIG. 16 is a section diagram showing a state where an optical element is stored in the first housing.

### DETAILED DESCRIPTION OF EXEMPLARY EMBODIMENTS

An optical connector according to a first embodiment of the invention will be described below.

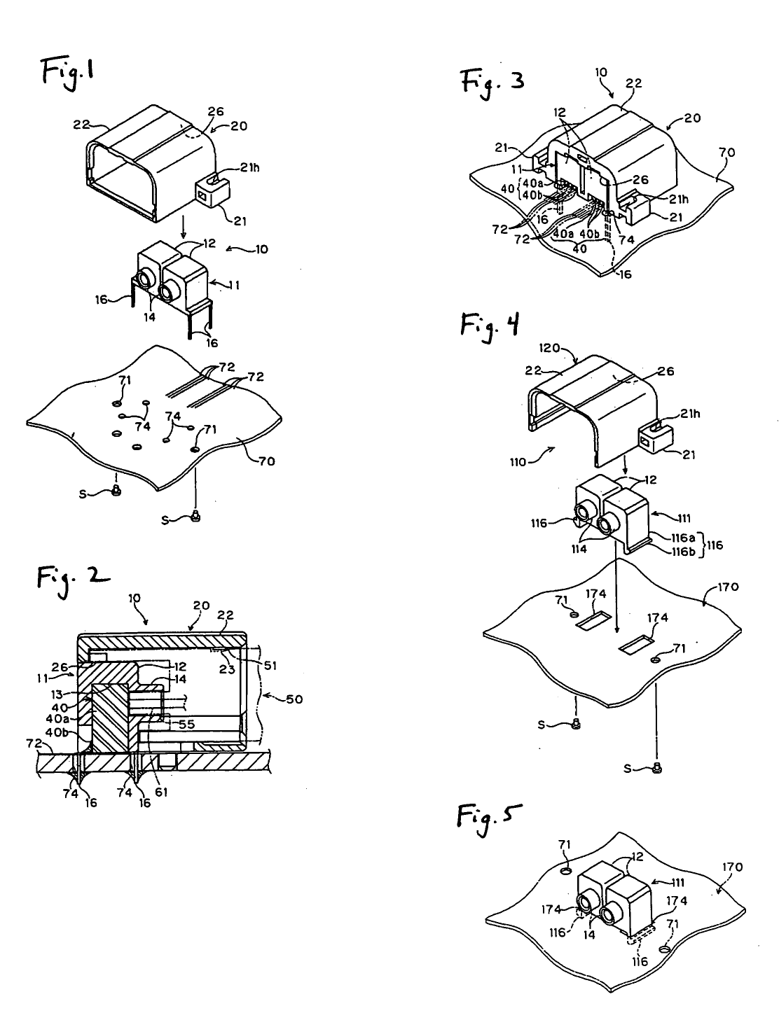

FIG. 1 is an exploded perspective diagram showing an optical connector 10. FIG. 2 is a section diagram showing the optical connector 10. FIG. 3 is a perspective diagram showing a state where the optical connector 10 is implemented and fixed to a wiring substrate 70.

The optical connector 10 stores an optical element 40. The optical connector 10 is implemented and fixed on the wiring substrate 70. An optical connector 50 holding an optical fiber 61 at the other party can be fitted and be connected to the optical connector 10 implemented and fixed to the wiring substrate 70, as shown in FIG. 2.

The optical connector 10 includes the optical element 40, a first housing 11 and a second housing 20. The optical element 40 is a light-receiving element (such as a photo diode and a phototransistor) for converting optical signals to electric signals or a light-emitting element (such as a light-emitting diode and so on) for converting electric signals to optical signals. The optical element 40 is of the surface implemented type, i.e., the optical element 40 has an electrode portion 40b in an optical-element body portion 40a. More specifically, the optical element 40 has the thin-band-shaped electrode portion 40b substantially in an L-shape on the part from the surface of the lower back of the optical element body portion 40a to the bottom surface, as shown in FIG. 2. According to the first embodiment, the optical connector 10 has two optical elements 40.

The surface-implemented type optical element 40 can be advantageously implemented more easily to the wiring substrate 70 than an optical element with a lead terminal, which is conventionally used in general. The first housing 11 includes a first housing body portion 12, a guide sleeve portion 14 and a fixing pin 16, which is a first mounting portion. When the first housing 11 is provided on the wiring substrate 70 as described later, the optical element 40 is surface-implemented on the wiring substrate 70 by reflow soldering. Thus, the damages on the first housing 11 can be prevented. The first housing 11 preferably contains a material, which does not melt at the processing temperature or higher, i.e., at the soldering temperature. In order to efficiently release the heat generated in the optical element 40 to the outside, the first housing 11 preferably contains a highly conductive material, i.e., a material having a higher thermal conductivity than that of the second housing 20. The materials satisfying these conditions are metal materials such as copper and alloys of copper.

The first housing body portion 12 has a substantial cuboid cabinet shape. The bottom side of the first housing body portion 12 opens. The first housing body portion 12 contains an element storing depression 13. The element storing depression 13 can store and hold optical element 40 such that the optical element 40 can be surface-implemented on the top surface, which is one main surface, of the wiring substrate 70. In other words, the element storing depression 13 has an internal form, which is substantially the same as the external form of the optical element 40. The back bottom part of the housing body portion 12 opens. When the optical element 40 is stored in the element storing depression 13, the electrode portion 40b of the optical element 40 is exposed through the bottom opening and back bottom side opening of the first housing body portion 12. When the first housing body portion 12 is provided on the wiring substrate 70, the electrode portion 40b is arranged in contact with or closely to a predetermined wiring pattern 72 on the top surface side of the wiring substrate 70. The electrode portion 40b can be soldered to the wiring pattern 72.

A guide sleeve portion 14 projects toward the front surface of the first housing body portion 12. The guide sleeve portion 14 has a substantial-tube shape having a hole, through which a ferrule portion 55 of the optical connector 50 of the other party can be inserted and which communicates to each of the element storing depression 13. When the optical connector 10 and the optical connector 50 are connected, the ferrule portion 55 is inserted to the respective sleeve portion 14 and is guided toward the optical element 40 of the respective element storing depression 13. When each of the ferrule portions 55 is completely inserted to the respective sleeve portion 14, the end front of the optical fiber 61 exposing at the pointed end of the ferrule portion 55 faces toward and optically connects to the light emitting or light receiving surface of the respective optical element 40.

According to the first embodiment, two housing body portions 12 are connected to each other at the bottoms, and each of the housing body portions 12 stores the optical element 40. The fixing pin 16 is a member for mounting the first housing body portion 12 onto the top surface of the wiring substrate 70. Especially, the mounted position of the first housing body portion 12 can be freely adjusted in the planer direction of the wiring substrate 70.

The fixing pin 16 is vertically provided downward from four apexes of the bottom part of the first housing 11. The outer diameter of the fixing pin 16 is smaller than the inner diameter of a through-hole 74 of the wiring substrate 70. Therefore, the fixing pin 16 is movably laid in the through-hole 74 and is movable within the through-hole 74 in a predetermined free width in the planer direction of the wiring substrate 70. When the fixing pin 16 is movably laid in the through-hole 74, the pointed end of the fixing pin 16 projecting to the bottom surface, which is the other main surface opposite to the top surface, of the wiring substrate 70 can be soldered to a land pattern 76 on the bottom surface of the wiring substrate 70.

Before soldering the fixing pin 16 to the wiring substrate 70, the position mounting the first housing body portion 12 can be freely adjusted in the planer direction of the wiring substrate 70 in a range that the fixing pin 16 can move within the through-hole 74. By soldering and securing the fixing pin 16 to the wiring substrate 70, the first housing 11 is secured to a predetermined position of the wiring substrate 70.

A second housing 20 contains resin and can be mounted and fixed to the wiring substrate 70 by covering the first housing 11. The second housing 20 also allows the optical connector 50 of the other party to fit and to connect. In other words, the second housing 20 substantially has a flat tube shape. One end of the second housing 20 is provided in a connecting tube portion 22 to which the optical connector 50 of the other party can be fitted and be connected. The other end is provided in a housing storing portion 26 for storing and covering the first housing 11.

The housing storing portion 26 has an internal space, which can store the first housing 11, as shown in FIGS. 2 and 3. Because the force given to the second housing 20 makes the first housing 11 hard to act, the housing storing portion 26 preferably covers the first housing 11 with a predetermined amount of space therebetween, such that the first housing 11 and the housing storing portion 26 do not directly touch each other. The back side of the housing storing portion 26 opens, and the first housing 11 is stored in the housing storing portion 26. Thus, the back of the first housing 11 is exposed to the outside through the back side opening of the housing storing portion 26.

The connecting tube portion 22 has a substantial tube form to which the optical connector 50 can fit. The connecting tube portion 22 is mounted and fixed on the wiring substrate 70 and is provided at a position enclosing both of the guide sleeve portions 14. When the optical connector 50 of the other party is fit-connected to the connecting tube portion 22, the ferrule portion 55 is guided toward the guide sleeve portion 14. The housing storing portion 26 has a lock portion 23, which can associate with the optical connector 50 of the other party.

A depression-shaped locked portion 51 is provided on the top surface of the housing of the optical connector 50 of the other party, and the projection-shaped lock portion 23 is provided at a position facing toward the locked portion 51. When both of the optical connectors 10 and 50 are fit-connected, the lock portion 23 associates with the locked portion 51. Thus, the connection state between the optical connectors 10 and 50 can be maintained.

Furthermore, the second housing 20 includes a second mounting portion, which can be secured to the wiring substrate 70. The securing force of the second mounting portion to the wiring substrate 70 is larger than the securing force of the first mounting portion (fixing pin 16) to the wiring substrate 70. Here, a screwed portion 21, which can be screwed to the wiring substrate 70, is used as the second mounting portion.

A pair of the screwed portions 21 having screw holes 21h projecting outward is provided on both sides of the second housing 20. When the second housing 20 is provided on the top surface of the wiring substrate 70, a screw S is inserted through the screw insert hole 71 of the wiring substrate 70 from the bottom of the wiring substrate 70 and is screwed to the screw hole 21h. Thus, the second housing 20 is fixed to the wiring substrate 70.

The steps for implementing and securing the optical connector 10 having the above-described construction on the top surface of the wiring substrate 70 will be described.

Each of the optical elements 40 is stored in the respective element storing depression 13 of the first housing 11. On the other hand, a soldering paste is coated on a predetermined area of the wiring pattern 72 of the wiring substrate 70 in advance. The electrode portion 40b of the optical element is provided on the wiring pattern 72, and the fixing pin 16 is inserted to the fixing pin 16.

By exposing the soldering paste on the wiring pattern 72 to a high temperature atmosphere, the soldiering paste is melted in a well-known reflow soldering apparatus. Then, the electrode portion 40b of the optical element 40 is soldered to the wiring pattern 72. Even when the position mounting the optical element 40 is slightly displaced from the correct position, the first housing 11 moves to the position in accordance with the displacement in the planer direction of the wiring substrate 70.

Next, soldering in a soldering tub is supplied to the bottom surface side of the wiring substrate 70 by a well-known flow soldering apparatus, and the fixing pin 16 is soldered to the wiring substrate 70. The first housing 11 is mounted and fixed on the wiring substrate 70 at a position adjusted in accordance with the position mounting the optical element 40. Therefore, the relative displacement between the optical element 40 and the first housing 11 can be prevented.

Next, the second housing 20 is provided on the wiring substrate 70 by covering the first housing 11. Then, the screw S is screwed into the screw hole 21h of the screwed portion 21 from the bottom of the wiring substrate 70. Thus, the second housing 20 is screwed to the wiring substrate 70. Because the first housing 11 and the second housing 20 are separate bodies, the compression and torsion stresses from such screwing are less prone to be transferred to the soldering part of the optical element 40 than for a conventional unitary example. In this way, the first housing 11 is stored in and integrated to the second housing 20.

When the optical connector 50 of the other party is connected to the optical connector 10 implemented and fixed onto the wiring substrate 70, the optical connector 50 of the other party is first inserted and is connected to the second housing 20. Then, when the optical connector 50 is deeply inserted, the ferrule portion 55 is inserted to the respective guide sleeve portion 14 and is guided toward the optical element 40 of the element storing depression 13. When the optical connector 50 is inserted completely, the end front of the optical fiber 61 faces toward the light-emitting surface or the light-receiving surface, and both of them are optically connected. With this connection, the lock portion 23 associates with the locked portion 51, and the connection of the optical connectors 10 and 50 can be maintained.

The optical connector 50 is inserted and connected to the second housing 20 so that the optical connector 50 can be roughly guided, and the ferrule portion 55 can be guided toward the guide sleeve portion 14. The ferrule portion 55 on the optical connector side is inserted into the guide sleeve portion 14 so that the optical axes of the optical fiber 61 and the optical element 40 can be matched highly precisely. The lock portion 23 of the second housing 20 side associates with the locked portion 51 of the optical connector 50 side so that the connection of the optical connectors 10 and 50 can be solidly maintained.

In the optical connector having the above-described construction, the position mounting the first housing body portion 12 can be adjusted. Therefore, by adjusting the position mounting the first housing 11, in accordance with the position mounting the optical element 40, the difference between the mounting positions of the optical element 40 and first housing 11 can be prevented. Thus, the transfer of stresses to the soldering part between the electrode portion 40b of the optical element 40 and the wiring pattern 72 of the wiring substrate 70 can be prevented. As a result, defects such as soldering cracks, unsoldering, and poor contacts can be prevented.

By soldering the fixing pin 16 to the wiring substrate 70 side, the first housing 11 can be mounted and fixed to the wiring substrate 70. Therefore, the position mounting the first housing 11 can be adjusted before the soldering, and the first housing 11 can be fixed to the wiring substrate 70 more securely after the soldering.

The first housing 11 and the wiring substrate 70 do not have to be always mounted and fixed by soldering. For example, resin melting at a soldering temperature may be used for the fixing in the same manner as soldering. Alternatively, a resin adhesive may be used for the mounting and fixing. The second housing 20 to which the optical connector 50 of the other party can fit and connect is mounted and fixed to the wiring substrate 70 by covering the first housing 11. Thus, even when a large force is applied to the optical connector 50 of the other party, the force can be received by the second housing 20. Because such a large force is hard to apply to the first housing 11 and the optical element 40, the stresses to the soldering part can be securely prevented/alleviated/avoided. [!!!!]

Furthermore, the lock portion 23 associates with the locked portion 51 so that the connection of the optical connectors 10 and 50 can be maintained. Therefore, even when a pulling force is applied to the optical connector 50 because the optical fiber 61 is pulled, for example, the force is received by the second housing 20. Because of this, the transfer of stresses to the soldering part can be prevented, and enable more secure connection. In particular, because the second housing 20 is screwed and fixed to the wiring substrate 70, the force can be received more securely.

The first embodiment is applied in an environment, such as the use in a vehicle, where vibration and/or large force are applied to the optical connector 50 and/or the optical fiber 61. However, when the first embodiment is used in an environment, such as the use in general home electric appliances, where that kind of vibration and/or force are not easily applied thereto, the second housing 20 may be omitted.

The first housing 11 contains a material having a higher conductivity, such as a material of copper, than that of the second housing 20, and the partial back side is exposed to the outside of the second housing 20. Therefore, the heat generated in the optical element 40 can be efficiently released from the first housing 11 to the outside. As a result, the heat radiation characteristic of the optical element 40 can be improved.

The part of the first housing 11 to be exposed to the outside of the second housing 20 may have a heat radiation form (such as a fin form) having multiple outward projections for heat radiation.

Next, an optical connector according to a second embodiment will be described.

FIG. 4 is an exploded perspective diagram showing an optical connector 110. FIG. 5 is a perspective diagram showing a state where a first housing 111 is mounted and fixed to a wiring substrate 170. FIG. 6 is a front diagram showing a state where the first housing 111 is mounted and fixed to the wiring substrate 170. In the description of the second embodiment, the same reference numerals will be given to the elements having the same functions as those of the optical connector 10 according to the first embodiment, and the description will be omitted. The differences will be mainly described.

In the optical connector 110, a second housing 120 has the same construction as that of the second housing 20 according to the first embodiment except for the removal of the bottom part to be provided on the wiring substrate 70. Therefore, the construction of the second housing 20 can be simplified.

The bottom part of the optical connector 50 is slidably in contact with the top surface of the wiring substrate 70, and the optical connector 50 fits and connects to a tube-shape space established by the second housing 120 and the wiring substrate 70. In the first housing 111 of the optical connector 110, a substrate fixing lock portion 116 is provided as a first mounting portion instead of the fixing pin 16. The substrate fixing lock portion 116 has an extending lock piece 116a and a lock projection 116b.

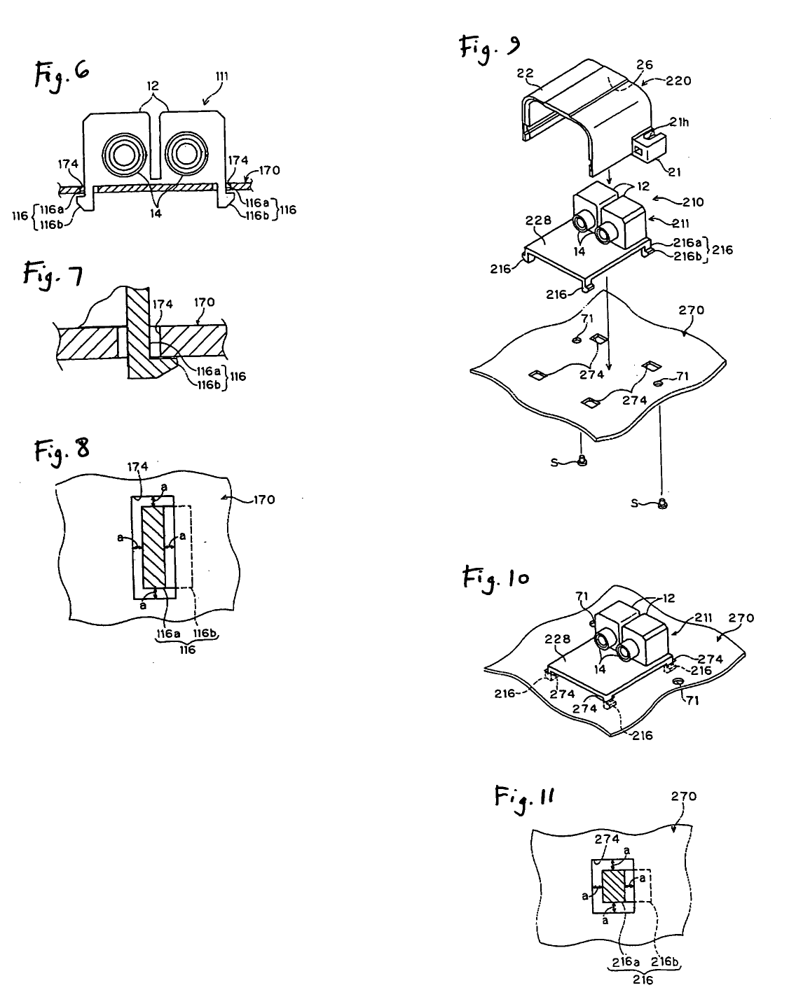

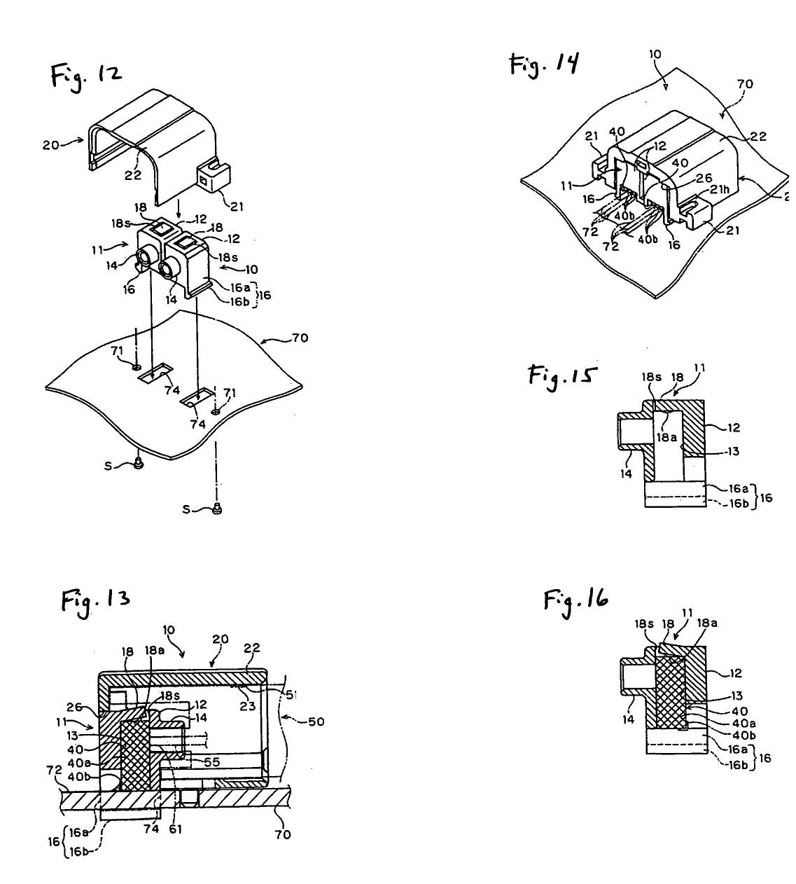

FIG. 7 is a vertical section diagram showing a state where the substrate fixing lock portion 116 associates with the wiring substrate 170. FIG. 8 is a horizontal section diagram showing the same state. The extending lock piece 116a can be movably inserted to an associating hole 174 for fixing the first housing 111 in the wiring substrate 170.

A pair of the extending lock pieces 116a is provided downward from the both sides of the first housing 111. The sectional form of the extending lock piece 116a is larger than a plane view form of the associating hole 174. Therefore, the extending lock piece 116a is movable in a predetermined range “a” in a planer direction of the wiring substrate 170. In FIG. 8, the range “a” is drawn in exaggerated fashion. The lock projection 116b projects at the pointed end of the extending lock piece 116a and can removably associate with the outer edge of the associating hole 174 from the bottom surface side of the wiring substrate 170.

More specifically, the lock projection 116b projects from the pointed end of the extending lock piece 116a to the outside of the first housing 111. The distance between the top surface of the lock projection 116b and the bottom part of the first housing 111 is substantially the same as the thickness of the wiring substrate 170. When the lock projection 116b removably associates with the outer edge of the associating hole 174 on the bottom surface side of the wiring substrate 170, the bottom part of the first housing 111 is abutted to the top surface of the wiring substrate 170. The first housing 111 is positioned substantially in perpendicular to the wiring substrate 170.

The bottom surface of the lock projection 116b has an inclined surface internally inclining as the distance to the outside of the first housing 111 decreases. The lock projection 116b can be easily inserted to the associating hole 174. In order to implement and fix the optical connector 110 on the wiring substrate 170, the substrate fixing lock portion 116 is associated with the associating hole 174 such that the first housing 11 can be fixed to the wiring substrate 170.

When the optical element 40 is stored in the element storing depression 13 of the first housing 111, the first housing 111 is provided on the wiring substrate 170. Then, the substrate fixing lock portion 116 is associated with the associating hole 174.

The first housing 111 can move in the predetermined range “a” in the planer direction of the wiring substrate 170. Therefore, the position of the optical element 40 can be adjusted by moving the optical element 40 and the first housing 111 to a predetermined implemented position where the electrode portion 40b of the optical element 40 is in contact with and is provided on the wiring pattern of the wiring substrate 170. Therefore, when a difference in positional relation between the wiring pattern and the associating hole 174 occurs, the position mounting the first housing 111 can be adjusted in accordance with the position mounting the optical element 40.

After that, a soldering paste on the wiring pattern is exposed in a high temperature environment and is melted in a well-known reflow soldering apparatus, and the electrode portion 40b of the optical element 40 is soldered to the wiring pattern. In this case, when the position of the optical element 40 is displaced during the reflow soldering, the position of the first housing 111 can be also adjusted in accordance therewith.

Therefore, the relative displacement between the optical element 40 and the first housing 111 can be prevented. After that, the substrate fixing lock portion 116 may be soldered or fixed with an adhesive to the wiring substrate 170 side. After the optical element 40 is surface-implemented to the wiring substrate 170, the optical element 40 may be covered with the first housing 111, and the substrate fixing lock portion 116 may be associated with the associating hole 174.

The same effects as those of the first embodiment can be obtained even by using the optical connector according to the second embodiment. In addition, by associating the substrate fixing lock portion 116 of the first housing 111 with the wiring substrate 170, the first housing 111 can be mounted and be fixed thereto. Therefore, the mounting can be performed easily.

Next, an optical connector according to a third embodiment of the invention will be described.

FIG. 9 is an exploded perspective diagram showing an optical connector 210. FIG. 10 is a perspective diagram showing a state where a first housing 211 is mounted and fixed to the wiring substrate 270. FIG. 6 is a front view showing a state where the first housing 211 is mounted and fixed to the wiring substrate 270. In the description of the third embodiment, the same reference numerals will be given to the elements having the same functions as those of the optical connector 10 according to the first embodiment, and the description will be omitted. The differences will be mainly described.

In the optical connector 210, a second housing 220 does not have a bottom part like the second housing 120, according to the second embodiment.

In the first housing 211, a plate-like bottom part 228 included in the bottom part of the second housing 20 extends to the front bottom side of the first housing 11 according to the first embodiment. The plate-like bottom part 228 establishes the second housing 220 by combining the first housing 211 and the second housing 220. The optical connector 50 of the other party fits and connects to a tube-shaped space enclosed by the second housing 220 and the plate-like bottom part 228. Substrate fixing lock portions 216 project at four apexes of the bottom part of the first housing 211.

Each of the substrate fixing lock portions 216 is only different from the substrate fixing lock portion 116 in length in the front-and-back direction of the first housing 211. Like the substrate fixing lock portion 116, a lock projection 216b projects from the pointed end of each of extending lock pieces 216a to the outside of the first housing 211.

Then, when the extending lock pieces 216a are movably inserted to associating holes 274 of the wiring substrate 270, the lock projections 216b are removably associated with the outer edges of the associating holes 274 from the bottom surface side of the wiring substrate 270. Thus, the first housing 211 can be mounted and be fixed to the wiring substrate 270 by adjusting the position of the first housing 211 freely.

The same effects as those of the first and second embodiments can be obtained with the optical connector 210. According to the third embodiment, the optical connector 10 is on the bipolar type including two optical elements 40. However, the one polar type or three or more polar type optical connector may be also applied.

An optical connector according to a fourth embodiment of the invention will be described below.

FIG. 12 is an exploded perspective diagram showing an optical connector 10 in a fourth embodiment. FIG. 13 is a section diagram showing the optical connector 10. FIG. 14 is a perspective diagram showing a state where the optical connector 10 is implemented and fixed onto a wiring substrate 70.

The optical connector 10 stores an optical element 40 and is implemented and fixed on the wiring substrate 70. An optical connector 50 holding an optical fiber 61 at the other party can be fitted and be connected to the optical connector 10 implemented and fixed onto the wiring substrate 70, as shown in FIG. 13. The optical connector 10 includes the optical element 40, a first housing 11 and a second housing 20. The optical element 40 is a light-receiving element (such as a photo diode and a phototransistor) for converting optical signals to electric signals or a light-emitting element (such as a light-emitting diode) for converting electric signals to optical signals. The optical element 40 is of the surface implemented type, i.e., the optical element 40 has an electrode portion 40b in an optical-element body portion 40a.

More specifically, the optical element 40 has the thin-band-shaped electrode portion 40b substantially in an L-shape on the part from the surface of the lower back of the optical element body portion 40a to the bottom surface, as shown in FIG. 13. According to the fourth embodiment, the optical connector 10 has two optical elements 40. The surface-implemented type optical element 40 can be advantageously implemented more easily to the wiring substrate 70 than an optical element with a lead terminal, which is conventionally used in general.

FIG. 15 is a section diagram of the first housing 11. FIG. 16 is a section diagram showing a state where the optical element is stored in the first housing 11.

As shown in FIGS. 12 to 16, the first housing 11 includes a first housing body portion 12, a guide sleeve portion 14, a mounting lock portion 16 as a mounting portion and an elastic forcing piece 18 as an element forcing portion. When the first housing 11 is provided on the wiring substrate 70 as described later, the optical element 40 is surface-implemented on the wiring substrate 70 by reflow soldering, for example.

According to the fourth embodiment, two housing body portions 12 are connected to each other at the bottoms, and each of the housing body portions 12 stores the optical element 40. The mounting lock portion 16 can be lockably associated with the associating hole 74 by being inserted to the wiring hole 74 on the wiring substrate 70 from the top surface side of the wiring substrate 70.

More specifically, a pair of mounting lock portion 16 is provided on both sides of the first housing 11. Each of the mounting lock portions 16 includes an extending lock piece 16a extending downward from both sides of the first housing 11 and a lock projection 16b projecting at the pointed end of the extending lock piece 16a.

The extending lock piece 16a has a long-plate shape, which can be inserted to the associating hole 74 on the wiring substrate 70. The lock projection 16b projects outward from the pointed end of the extending lock piece 16a. The lock projection 16b can associate with the peripheral edge of the associating hole 74 on the bottom surface side of the wiring substrate 70.

The distance between the top surface of the lock projection 16b and the bottom part of the first housing 11 is substantially equal to the thickness of the wiring substrate 70. When the lock projection 16b is lockably associated with the peripheral edge of the associating hole 74 on the bottom surface side of the wiring substrate 70, the bottom part of the first housing 11 is abutted to the top surface of the wiring substrate 70. Thus, the first housing 11 is positioned substantially in perpendicular to the wiring substrate 70.

The bottom surface of the lock projection 16b has an inclined surface internally inclining as the distance to the outside of the first housing 11 decreases. When the mounting lock portion 16 is inserted from the above of the wiring substrate 70 to the corresponding associating hole 74, the inclined surface is first slidably in contact with the peripheral edge of the associating hole 74, and the extending lock piece 16a elastically deforms toward the inside of the first housing 11. When the lock projection 16b is beyond the inner radius part of the associating hole 74, the extending lock piece 16a returns to the original straight line. Then, the lock projection 16b lockably associates with the associating hole 74 on the bottom surface side of the wiring substrate 70.

As described later, the lock projection 16b has a function for maintaining a state where the bottom part of the first housing 11 is tightly in contact with the top surface of the wiring substrate 70 when the optical element 40 is surface-implemented to the wiring substrate 70. Elements for performing the function include the lock projection 16b as described above and a construction for fixing the first housing 11 by soldering or with an adhesive. In other words, various applicable constructions can be adopted for mounting and fixing the housing body portion 12 to the wiring substrate 70 when the bottom part of the first housing body portion 12 is tightly provided on the main surface of the wiring substrate 70.

A tongue-shaped elastic forcing piece 18 is obtained by providing a substantial U-shaped slit 18s on the ceiling of the first housing body portion 12. In other words, one side of the periphery of the elastic forcing piece 18 connects to the ceiling part of the first housing body portion 12. The other part of the periphery of the elastic forcing piece 18 is separated from the ceiling part of the first housing body portion 12 through the slit 18s. The elastic forcing piece 18 can elastically deform toward the inside and outside of the ceiling with respect to the connecting part with the ceiling part of the first housing body portion 12.

A projection 18a is provided on an internal surface of the elastic forcing piece 18, as shown in FIG. 15. When the optical element 40 is inserted to the element storing depression 13, the projection 18a is abutted to the top surface of the element body portion 40a of the optical element 40. When the optical element 40 is inserted to the element storing depression 13 more deeply, the projection 18a is pressed upward. Then, the elastic forcing piece 18 elastically deforms upward. Under this condition, the optical element 40 is forced downward through the projection 18a by using the elastic restoration force of the elastic forcing piece 18.

The construction of the elastic forcing piece 18 is not limited to the above-described construction. For example, the projection 18a may be omitted, and the elastic forcing piece 18 may be bent toward the inside of the first housing body portion 12. Instead of the forming of the tongue-shaped elastic forcing piece 18 by processing the housing body portion 12 itself, the elastic member such as other flat springs and coil springs may be provided on the ceiling part within the element storing depression 13, and the optical element 40 may be forced toward the bottom side. In other words, various kinds of elastic forcing unit, which can force the optical element 40 stored in the element storing depression 13 to the bottom side may be used as an element forcing portion.

A second housing 20 contains resin and can be mounted and be fixed to the wiring substrate 70 by covering the first housing 11. The optical connector 50 of the other party can fit and connect to the second housing 20. In other words, the second housing 20 substantially has a flat tube shape. One end of the second housing 20 is provided in a connecting tube portion 22 to which the optical connector 50 of the other party can be fitted and be connected. The other end is provided in a housing storing portion 26 for storing and covering the first housing 11.

The housing storing portion 26 has an internal space, which can store the first housing 11, as shown in FIGS. 13 and 14. Because the force given to the second housing 20 inhibits movement of the first housing 11, the housing storing portion 26 preferably covers the first housing 11 with a predetermined amount of space therebetween such that the first housing 11 and the housing storing portion 26 do not directly touch each other. The back side of the housing storing portion 26 opens, and the first housing 11 is stored in the housing storing portion 26. Thus, the back of the first housing 11 is exposed to the outside through the back side opening of the housing storing portion 26.

The connecting tube portion 22 has a substantial tube shape to which the optical connector 50 can internally fit. The connecting tube portion 22 is mounted and fixed on the wiring substrate 70 and is provided at a position enclosing both of the guide sleeve portions 14. When the optical connector 50 of the other party is fitted and is connected to the connecting tube portion 22, the ferrule portion 55 is guided toward the guide sleeve portion 14. The housing storing portion 26 has a lock portion 23, which can latch to the optical connector 50 of the other party.

A depression-shaped locked portion 51 is provided on the top surface of the housing of the optical connector 50 of the other party, and the projection-shaped lock portion 23 is provided at a position facing toward the locked portion 51 on the inner top surface of the connecting tube portion 22. When both of the optical connectors 10 and 50 are fitted and are connected, the lock portion 23 associates with the locked portion 51. Thus, the connection state between the optical connectors 10 and 50 can be maintained.

Furthermore, the second housing 20 includes a mounting and fixing portion 21, which can be secured to the wiring substrate 70. The securing force of the mounting and fixing portion 21 to the wiring substrate 70 is larger than the securing force of the mounting lock portion 16 to the wiring substrate 70. Because the second housing 20 is more robustly fixed to the wiring substrate 70, the mounting and fixing portion adopts the construction, which can be screwed to the wiring substrate 70.

In other words, a pair of the mounting and fixing portions 21 having screw holes 21h projecting outward are provided on both sides of the second housing 20. When the second housing 20 is provided on the top surface of the wiring substrate 70, a screw S is inserted through the screw insert hole 71 of the wiring substrate 70 from the bottom of the wiring substrate 70 and is screwed to the screw hole 21h. Thus, the second housing 20 is screwed to the wiring substrate 70.

The steps for implementing and securing the optical connector 10 having the above-described construction on the top surface of the wiring substrate 70 will be described.

Each of the optical elements 40 is stored in the respective element storing depression 13 of the first housing 11. On the other hand, a soldering paste is coated on a predetermined area of the wiring pattern 72 of the wiring substrate 70 in advance. The electrode portion 40b of the optical element 40 is provided on the corresponding wiring pattern 72. At the same time, the mounting lock portion 16 is inserted from the top surface side of the wiring substrate 70 to the associating hole 74 and lockably associated with the associating hole 74. Thus, the first housing 11 is mounted and fixed to the top surface of the wiring substrate 70.

Under this condition, the optical element 40 is forced toward the top surface of the wiring substrate 70 by using the elastic restoration force of the elastic forcing piece 18. Therefore, the bottom part of the optical element 40 is pressed tightly against the top surface of the wiring substrate 70. Then, the electrode portion 40b is more securely provided tightly or closely in contact with the corresponding wiring pattern 72 so as to allow the reflow soldering.

The soldering paste on the wiring pattern 72 is exposed in a high temperature atmosphere and is melted in a well-known reflow soldering apparatus. Then, the electrode portion 40b of the optical element 40 is soldered to the wiring pattern 72. Because the soldering of the optical element 40 is performed when the first housing 11 is mounted and fixed to the wiring substrate 70, a difference between the mounting position of the first housing 11 and the mounting position of the optical element 40 does not occur easily. Therefore, stress due to the difference in mounting position does not occur easily in the soldering part between the electrode portion 40b of the optical element 40 and the wiring pattern 72. As a result, the cracks, unsoldering, poor contacts or the like in the soldering part can be advantageously prevented.

Next, the second housing 20 is provided on the wiring substrate 70 by covering the first housing 11. Then, the screw S is screwed into the screw hole 21h of the mounting and fixing portion 21 from the bottom of the wiring substrate 70. Thus, the second housing 20 is screwed to the wiring substrate 70. Because the first housing 11 and the second housing 20 are separate bodies, the transfer of stresses due to the screwing is impeded to the soldering part of the optical element 40 than a conventional integrated example. In this way, the first housing 11 is stored in and is integrated to the second housing 20.

When the optical connector 50 of the other party is connected to the optical connector 10 implemented and fixed onto the wiring substrate 70, the optical connector 50 of the other party is first inserted and is connected to the second housing 20. Then, when the optical connector 50 is deeply inserted, the ferrule portion 55 is inserted to the respective corresponding guide sleeve portion 14 and is guided toward the optical element 40 of the element storing depression 13. When the optical connector 50 is inserted completely, the end front of the optical fiber 61 faces toward the light-emitting surface or the light-receiving surface of the optical element 40, and both of them are optically connected. With this connection, the lock portion 23 associates with the locked portion 51, and the connection of the optical connectors 10 and 50 can be maintained.

The optical connector 50 is inserted and is connected to the second housing 20 so that the optical connector 50 can be roughly guided, and the ferrule portion 55 can be guided toward the guide sleeve portion 14. The ferrule portion 55 on the optical connector side is inserted into the guide sleeve portion 14 so that the optical axes of the optical fiber 61 and the optical element 40 can be matched highly precisely. The lock portion 23 of the second housing 20 side associates with the locked portion 51 of the optical connector 50 side so that the connection of the optical connectors 10 and 50 can be solidly maintained.

In the optical connector as described above, the optical element 40 can be soldered by forcing, with the elastic forcing piece 18, the optical element 40 toward the top surface of the wiring substrate 70. Therefore, the electrode portion 40b of the optical element 40 can be more securely soldered to the wiring pattern 72 of the wiring substrate 70. When the elastic forcing piece 18 is obtained by providing a substantial U-shaped slit 18s to the ceiling part of the housing body portion 12, the construction can be simplified without using separate members.

The mounting lock portion 16 is inserted to the associating hole 74 of the wiring substrate 70 so as to lockably associate with the associating hole. Therefore, the first housing 11 can be easily mounted and be fixed on the wiring substrate 70. The second housing 20 to which the optical connector 50 of the other party can fit and connect is mounted and fixed to the wiring substrate 70 by covering the first housing 11. Thus, even when large force is applied to the optical connector 50 of the other party, the force can be received by the second housing 20. Because a large force is hard to apply to the first housing 11 and the optical element 40, the transfer of stresses to the soldering part can be reliably avoided.

Furthermore, the lock portion 23 associates with a locked portion 51 so that the connection of the optical connectors 10 and 50 can be maintained. Therefore, even when pulling force is applied to the optical connector 50 because the optical fiber 61 is pulled, for example, the force is received by the second housing 20. Also because of this, the transfer of stresses to the soldering part can be mitigated, and the connection is more secure.

The fourth embodiment is applied in an environment, such as the use in a vehicle, where vibration and/or large force, for example, are applied to the optical connector 50 and/or the optical fiber 61. However, when the fourth embodiment is used in an environment, such as the use in general home electric appliances, where that kind of vibration and/or force are not easily applied thereto, the second housing 20 may be omitted. Alternatively, the first housing 11 and the second housing 20 can be integrated.

According to the fourth embodiment and the variation examples, the optical connector 10 is of the so-called bipolar type including two optical elements 40. However, the one polar type or three or more polar type optical connector may be also applied.

As described above, the invention provides an optical connector in which the position for mounting the first housing body portion can be adjusted. Therefore, the difference between the mounting position of the optical element and the mounting position of the first housing can be prevented. As a result, the transfer of stresses to the soldering part between the electrode portion of the optical element and the wiring pattern of the wiring substrate can be avoided.

The invention provides that the mounting position of the first housing body portion can be adjusted before the first mounting portion is fixed to the wiring substrate side by soldering or with resin. The invention provides that the mounting position of the first housing body portion can be adjusted in a rage where a fixing pin can be movably inserted to a through-hole of the wiring substrate side and can move. The invention provides that the mounting position of the first housing body portion can be adjusted in a rage where an extending lock piece can be movably inserted to an associating hole and can move.

The invention provides that when large force is applied to the optical connector of the other party, the force can be received by the second housing. Because such a large force is hard to apply to the first housing and the optical element, the transfer of stresses to the soldering part can be securely prevented. The invention provides that even when a pulling force is applied to the optical connector of the other party, the force is received by the second housing. Therefore, the transfer of stresses to the soldering part can be more reliably avoided.

The invention provides that the second housing can be securely fixed to the wiring substrate. The invention provides that the heat generated in the optical element can be efficiently released from the first housing to the outside. As a result, the heat radiation characteristic of the optical element can be improved. The invention provides that prevention of damage to the first housing due to the surface-implementing of the optical element.

As described above, the invention provides an optical connector in which the optical element can be soldered by forcing, with the element forcing portion, the optical element toward the main surface of the wiring substrate. Therefore, the electrode portion of the optical element can be more securely soldered to the wiring pattern of the wiring substrate.

The invention provides that the mounting lock portion is inserted to and is associated with the associating hole of the wiring substrate. Therefore, the first housing can be easily mounted and be fixed on the wiring substrate. The invention provides when the tongue-shaped elastic forcing piece is obtained by providing a substantial U-shaped slit to the ceiling part of the housing body portion, the construction can be simplified without using separate members.

The invention provides when large force is applied to the optical connector of the other party, the force can be received by the second housing. Because such a large force is hard to apply to the first housing and the optical element, the transfer of stresses to the soldering part can be securely prevented. The invention provides even when pulling force is applied to the optical connector of the other party, the force is received by the second housing. Therefore, the transfer of stresses to the soldering part can be more reliably avoided.

While this invention has been described in conjunction with exemplary embodiments outlined above, many alternatives, modifications and variations will be apparent to those skilled in the art. Accordingly, the exemplary embodiments of the invention, as set forth above, are intended to be illustrative, not limiting. Various changes can be made without departing from the spirit and scope of the invention.

What is claimed is:

1. An optical connector implemented and fixed to a wiring substrate, comprising:
a surface-implemented type optical element; and
a first housing having a first housing body portion having:
an element storing depression, which can store and hold the optical element so as to surface-implement the optical element on a main surface of the wiring substrate,
a guide sleeve portion for guiding a fiber so as to optically connect to the optical element, and
a first mounting portion for mounting the first housing body portion onto the main surface of the wiring substrate,
wherein the first mounting portion is arranged such that a position for mounting the first housing body portion can be freely adjusted in the planer direction of the wiring substrate.

2. The optical connector according to claim 1, wherein the first mounting portion is arranged such that the first mounting portion can be fixed to the wiring substrate side by soldering or with resin.

3. The optical connector according to claim 1, wherein the first mounting portion has a fixing pin, which can be movably inserted to a through-hole for fixing the first housing formed on the wiring substrate side, and the fixing pin is arranged such that the fixing pin can be fixed to the wiring substrate side by soldering or with resin.

4. The optical connector according to claim 1, wherein the first mounting portion is a substrate fixing lock portion having:
an extending lock piece, which can be movably inserted to an associating hole for fixing the first housing formed on the wiring substrate side, and
a lock projection, which projects at the pointed end of the extending lock piece and which can associate with the associating hole therethrough.

5. The optical connector according to claim 1, further comprising a second housing, mounted and fixed to the wiring substrate by covering the first housing, for guiding the optical fiber toward the guide sleeve portion by fitting, and for connecting the housing of an optical connector of the other party holding the optical fiber to the second housing.

6. The optical connector according to claim 5, wherein the second housing has a lock portion, which can be associated with the optical connector side of the other party.

7. The optical connector according to claim 5, wherein the second housing has a screwed portion, which can be screwed and fixed to the wiring substrate.

8. The optical connector according to claim 5, wherein the first housing contains a material having a higher conductivity than that of the second housing, and at least a part thereof is exposed to the outside of the second housing.

9. The optical connector according to claim 1, wherein the first housing contains a material, which does not melt at a processing temperature for surface-implementing the optical element thereto.

10. An optical connector storing an optical element and being implemented on a main surface of a wiring substrate, the optical connector comprising:
a surface-implemented type optical element having an electrode portion on a surface of an element body portion; and
a first housing having a housing body portion having:
an element storing depression, which stores and holds the optical element so as to surface-implement the optical element to the wiring substrate,
a guide sleeve portion for guiding an optical fiber so as to optically connect to the optical element, and
a mounting portion for mounting and fixing the housing body portion to the wiring substrate by providing the bottom part of the housing body portion tightly in contact with the main surface of the wiring substrate,
wherein an element forcing portion for forcing the optical element toward the main surface of the wiring substrate is provided in the housing body portion.

11. The optical connector according to claim 10, wherein the mounting portion is a mounting lock portion, which can lockably associate with an associating hole by being inserted from the main surface side of the wiring substrate to the associating hole formed on the wiring substrate side.

12. The optical connector according to claim 10, wherein the element forcing portion is a tongue-shaped elastic forcing piece, which is obtained by providing a substantial U-shaped slit on the ceiling part of the housing body portion.

13. The optical connector according to claim 10, further comprising a second housing, mounted and fixed to the wiring substrate by covering the first housing, for guiding the optical fiber toward the guide sleeve portion by fitting, and for connecting the housing of an optical connector of the other party holding the optical fiber to the second housing.

14. The optical connector according to claim 10, wherein the second housing has a lock portion, which can be latched with the optical connector of the other party.
